(19) United States
(12) Patent Application Publication
(10) Pub. No.: US 2022/0004676 A1
(43) Pub. Date: Jan. 6, 2022

(54) DESIGN ASSISTANCE DEVICE, DESIGN ASSISTANCE METHOD, AND DESIGN ASSISTANCE PROGRAM

(71) Applicant: OMRON Corporation, Kyoto-shi, KYOTO (JP)

(72) Inventors: Takeshi KIRIBUCHI, Osaks-shi, OSAKA (JP); Toshiyuki ZAITSU, Yokohama-shi, KANAGAWA (JP); Takeshi ASHIDA, Kyotanabe-shi, KYOTO (JP); Masashi DOI, Uji-shi, KYOTO (JP)

(21) Appl. No.: 17/419,461

(22) PCT Filed: Jan. 24, 2020
(86) PCT No.: PCT/JP2020/002574

§ 371 Date: Jun. 29, 2021

(30) Foreign Application Priority Data
Jan. 24, 2019 (JP) 2019-010567

(51) Int. Cl. G06F 30/17

(52) U.S. Cl. CPC G06F 30/17; G06F 2119/02

(57) ABSTRACT

The design assistance device includes: an acquisition unit configured to acquire system information indicating a configuration of the DC bus of the DC power supply system; and an output unit configured to output information on stability of the DC power supply system based on the system information acquired by the acquisition unit and a current value required for each operation of the one or more servo devices. With this configuration, it is possible to analyze the stability of a DC power supply system in which power is supplied from a DC power supply to one or more servo devices including an inverter circuit and an electric motor by a DC bus, in consideration of the configuration of the DC bus.

### TECHNICAL FIELD

The invention relates to a design assistance device, a design assistance method, and a design assistance program.

### BACKGROUND ART

In factories and the like, a system is used in which a plurality of electric motors are PWM-driven by a plurality of servo drivers arranged at remote locations (a system composed of a robot and its control device, and the like). In such a system, there are problems that the switching speed cannot be increased in order to reduce radiation noise from long cables between the motor and servo driver, and that many cables are required for the connection between the motor and servo driver.

If a configuration is adopted in which only the inverter circuit in the servo driver is placed near each motor and power is supplied to multiple inverter circuits from one DC power supply by a DC bus, it is possible to prevent the above problems from occurring.

However, in a system adopting this configuration, the LC circuit on the DC bus side and the inverter circuit side may interfere with each other and the system operation may become unstable (see, for example, Non-Patent Document 1). When wiring is performed with the actual product and oscillation is checked, man-hours are required because the actual wiring bus is modified to suppress oscillation. In addition, it is necessary to change the wiring bus by trial and error until oscillation can be suppressed, which requires more man-hours. Therefore, when adopting the above configuration, it is necessary to perform stability analysis in consideration of the inductance and the like on the DC bus side.

### PRIOR ART DOCUMENTS

### Non-patent Documents

Non-Patent Document 1: Masashi Yokoo, Keiichiro Kondo, “A Method to Design a Damping Control System for a Field Oriented Controlled Induction Motor Traction System for DC Electric Railway Vehicles”, IEEJ Transactions D, Vol. 135 No.6 pp. 622-631 (2015)

Non-Patent Document 2: R. D. Middlebrook, “Input Filter Considerations in Design and Application of Switching Regulators”, Proc, IEEE Industrial Application Society Annual Meeting pp. 363-382 (1976)

### SUMMARY OF THE INVENTION

### Problems to be Solved by the Invention

The invention has been made in view of the above situation, and has an object to provide a technique that can analyze (evaluate) the stability of a DC power supply system in which power is supplied from a DC power supply to one or more servo devices including an inverter circuit and an electric motor by a DC bus, in consideration of the configuration of the DC bus.

### Means for Solving the Problem

The design assistance device according to one aspect of the invention is a device that assists the design of a DC power supply system in which power is supplied from a DC power supply to one or more servo devices including an inverter circuit and an electric motor by a DC bus. Then, the design assistance device includes: an acquisition unit configured to acquire system information indicating a configuration of the DC bus of the DC power supply system; and an output unit configured to output information on stability of the DC power supply system based on the system information acquired by the acquisition unit and a current value required for each operation of the one or more servo devices. The system information is information related to the electrical characteristics based on the hardware configuration of the DC bus, and the stability of the DC power supply system has a strong relationship with the operating current value flowing through the DC bus. Therefore, according to the design assistance device having such a configuration, the stability of the DC power supply system can be analyzed (evaluated) in consideration of the configuration of the DC bus and the operating current in the servo device supplied with power from the DC bus.

Then, the output unit is configured to output information on stability of the DC power supply system based on Zₒ(s) and Zᵢₙ(s) (s is a Laplace operator) corresponding to the system information, and has a configuration in which when the DC power supply system is regarded as a connection system in which a load side portion including the one or more servo devices and a power supply side portion configured to supply power to the load side portion are connected, the Zₒ(s) is a formula expressing an output impedance of the power supply side portion as a function of s, and when the DC power supply system is regarded as the connection system, the Zᵢₙ(s) is a formula expressing an input impedance of the load side portion as a function of: s, a bus current value being a current value flowing through the DC bus, and a conversion rate a of the bus current value into a q-axis current of the electric motor.

That is, if there is system information indicating the configuration of the DC bus of the DC power supply system, the output impedance Zₒ(s) of the load side portion of the DC power supply system can be obtained. In addition, the input impedance Zᵢₙ(s) on the power supply side portion of the DC power supply system can be expressed a function of the bus current value and the conversion rate a of the bus current value into the q-axis current of the electric motor. It should be noted that the value of a can be calculated by assuming a command input into each servo device or by using a command actually input as the command. Then, from Zₒ(s) and Zᵢₙ(s), information on the stability of the DC power supply system (information indicating whether or not the DC power supply system is stable, such as the Nyquist plot of Zₒ(s)/Zᵢₙ(s) and the Bode plot of Zₒ(s) and Zᵢₙ(s)) can be obtained. Therefore, according to the design assistance device, the stability of the DC power supply system can be analyzed (evaluated) in consideration of the DC bus configuration (inductance of the DC bus, and the like).

The output unit of the design assistance device may output information on the stability of the DC power supply system in any form. Specifically, via the user interface, to the user and the like outside the design assistance device, the output unit may display the information on the stability of the DC power supply system (Nyquist plot or Bode plot) on the screen of the display, or may output data (numerical value group) representing the Nyquist plot or the like. In addition, the output form by the output unit also includes a form in which the information and data are output to another processing to be performed in an internal or external device of the design assistance device.

The output unit of the design assistance device may output information on the stability of the DC power supply system for each preset bus current value, or may output information on the stability of the DC power supply system for each bus current value designated by the user.

The output unit may obtain, from the following Formulas (1) to (4), the Zᵢₙ(s) when there is one servo device in the DC power supply system.

$$\begin{matrix}[ Mathematical 1 ] & \\ \frac{1}{{Z}_{i n} ( s )} = \frac{1}{{Z}_{N} ( s )} \frac{T ( s )}{1 + T ( s )} + \frac{1}{{Z}_{D} ( s )} \frac{1}{1 + T ( s )} & ( 1 ) \\ {Z}_{N} ( s ) = - \frac{{V}_{b}}{{I}_{b}} & ( 2 ) \\ {Z}_{D} ( s ) = \frac{1}{{α}^{2}} ( {R}_{m} + s {L}_{m} ) & ( 3 ) \\ T ( s ) = ( \frac{1}{{R}_{m} + s {L}_{m}} ) ( {K}_{p} + \frac{{K}_{i}}{s} ) & ( 4 )\end{matrix}$$

Herein, V_{b} and I_{b} are respectively a voltage and a current of the DC bus, Rₘ and Lₘ are respectively a resistance and an inductance of an electric motor, and Kₚ and Kᵢ are respectively a proportional gain and an integral gain of P1 control performed to cause a q-axis current to an electric motor to coincide with a current command.

Here, in the design assistance device described up to the above, the system information may include operation pattern information indicating each operation pattern of the one or more servo devices. By including the operation pattern, it is possible to derive information on the current value required for each operation of the one or more servo devices based on the operation pattern, and output the above information on stability by using the information on the current value.

In addition, the design assistance device described up to the above may further include a correction unit configured to correct the system information to satisfy the predetermined stability condition when information regarding stability of the DC power supply system output by the output unit does not satisfy a predetermined stability condition. With this configuration, it is possible to acquire system information in which the stability of the DC power supply system satisfies a predetermined stability condition through the correction processing by the correction unit. For example, the correction unit can correct the configuration of the DC bus. In addition, as an alternate method, when the system information includes the operation pattern information and information regarding stability of the DC power supply system does not satisfy the predetermined stability condition, the correction unit may correct the operation pattern corresponding to the operation pattern information so that a current value required for each operation of the one or more servo devices decreases.

The design assistance method according to one aspect of the invention for assisting design of a DC power supply system in which power is supplied from a DC power supply by a DC bus to one or more servo devices including an inverter circuit and an electric motor includes: acquiring system information indicating a configuration of the DC bus of the DC power supply system; and based on the system information and a current value required for each operation of the one or more servo devices, outputting information regarding stability of the DC power supply system. Furthermore, the design assistance method includes: based on the system information and a current value required for each operation of the one or more servo devices, regarding the DC power supply system as a system in which a load side portion including the one or more servo devices and a power supply side portion configured to supply power to the load side portion are connected, specifying Zₒ(s) being an output impedance of the power supply side portion, and as Zᵢₙ(s) being an input impedance of the load side portion, specifying a current value flowing through the DC bus and a function of a conversion rate a of the current value into a q-axis current of the electric motor, and based on the specified Zₒ(s) and the specified Zᵢₙ(s), outputting information regarding stability of the DC power supply system. In addition, the design assistance program according to one aspect of the invention causes a computer to operate as the design assistance device having any one of the above configurations. Therefore, also with these techniques, the stability of the DC power supply system can be analyzed (evaluated) in consideration of the DC bus configuration (inductance of the DC bus, and the like).

### Effect of the Invention

According to the invention, it is possible to analyze the stability of a DC power supply system in which power is supplied from a DC power supply to one or more servo devices including an inverter circuit and an electric motor by a DC bus, in consideration of the configuration of the DC bus.

### BRIEF DESCRIPTION OF THE DRAWINGS

FIG. 1 is a block diagram of a design assistance device according to one embodiment of the invention.

FIG. 2A is an explanatory diagram of a configuration example of a DC power supply system whose stability is analyzed by the design assistance device.

FIG. 2B is an explanatory diagram of a configuration example of a DC power supply system whose stability is analyzed by the design assistance device.

FIG. 3 is a control block diagram showing the control contents of a q-axis current of a controller included in a servo device.

FIG. 4 is an explanatory diagram of LC parallel circuit information.

FIG. 5 is an explanatory diagram of a Nyquist plot displayed by the design assistance device.

FIG. 6 is a control block diagram showing the control contents of the q-axis current used by the design assistance device to specify Z_{D}(s) and T(s).

FIG. 7 is an explanatory diagram of the experimental results conducted to check that the stability can be analyzed by the design assistance device.

FIG. 8 is a flowchart of design assistance processing by the design assistance device.

FIG. 9 is a diagram for illustrating correction processing of an initially input operation pattern by the design assistance processing.

### MODE FOR CARRYING OUT THE INVENTION

Hereinafter, embodiments of the invention will be described with reference to the drawings.

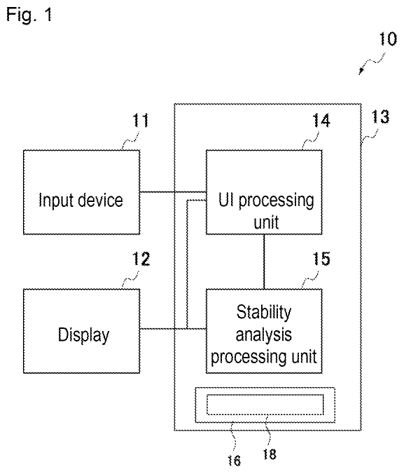

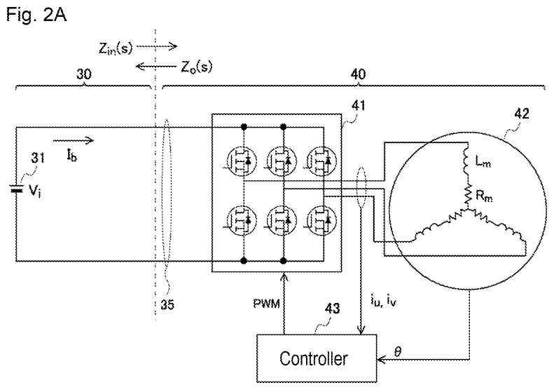

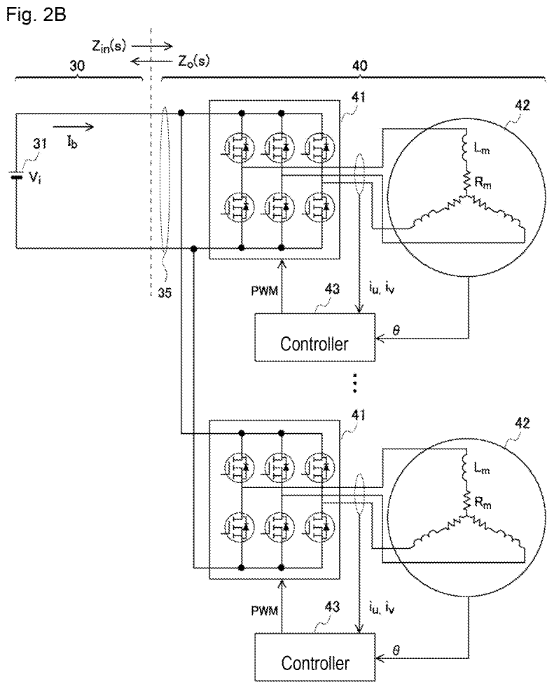

FIG. 1 shows a block diagram of the design assistance device 10 according to one embodiment of the invention, and FIGS. 2A and 2B show a configuration example of a DC power supply system whose stability is analyzed by the design assistance device 10.

The design assistance device 10 (FIG. 1) according to the present embodiment is a device developed to assist in the design of the DC power supply system by analyzing the stability of the DC power supply system with the configuration shown in FIG. 2A and FIG. 2B.

Specifically, as shown in FIGS. 2A and 2B, the DC power supply system (hereinafter, also referred to as the analysis target system) whose stability is analyzed by the design assistance device 10 is a system in which power from the DC power supply 31 is supplied, via the DC bus 35, to one (FIG. 2A) or more (FIG. 2B) servo devices composed of the inverter circuit 41, the electric motor 42, and the controller 43.

The electric motor 42 of each servo device in the analysis target system is a permanent magnet synchronous motor. In addition, the controller 43 of each servo device is a unit that performs vector control with non-interference compensation with d-axis current I_{d}=0 based on the information (θ, iᵤ, iᵥ in the figure) from the encoder (not shown) attached to the electric motor 42 and the sensor (not shown) that detects the drive current of the electric motor 42.

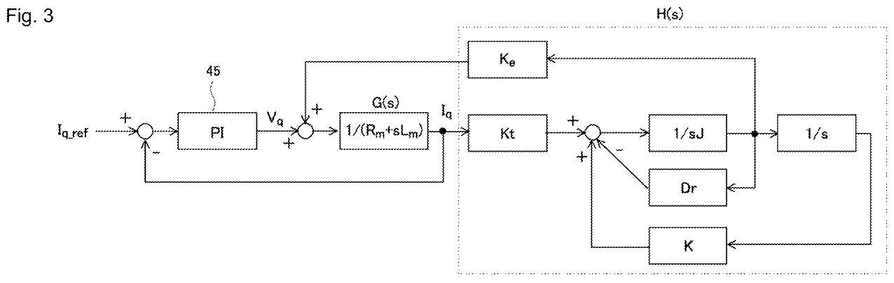

More specifically, the controller 43 is a unit that controls the q-axis current, as shown in FIG. 3. It should be noted that FIG. 3 is a control block diagram showing the control content of the q-axis current of the controller 43. In addition, in FIG. 3, Kt is the torque constant of the electric motor 42, and Ke is the induced voltage constant of the electric motor 42. J, Dr, and K are the inertia, viscosity, and spring constant of the mechanical system (the electric motor 42 and the machine driven by the electric motor 42), respectively. I_{q_ref} is the reference current (current command), and I_{q} is the current of the dq-converted electric motor 42 (q-axis current). The current compensator 45 is a PI compensator for causing I_{q} to coincide with I_{q_ref}.

Returning to FIG. 1, the configuration and function of the design assistance device 10 will be described.

As shown in the figure, the design assistance device 10 includes an input device 11 such as a keyboard and a mouse, a display 12, and a main body unit 13.

The main body unit 13 is a unit including a CPU (Central Processing Unit), a RAM (Random Access Memory), a non-volatile memory device 16 (hard disk drive, solid state drive, or the like), and the like. The design assistance program 18 is installed in the non-volatile memory device 16 of the main body unit 13, and the CPU reading and executing the design assistance program 18 on the RAM causes the main body unit 13 to operate as the UI processing unit 14 and the stability analysis processing unit 15.

The UI processing unit 14 is a unit that acquires system information and display target designation information from the user through operations on the input device 11 while displaying various image information on the screen of the display 12.

The system information acquired from the user by the UI processing unit 14 is information indicating the configuration and operation of the analysis target system. The UI processing unit 14 acquires the following information from the user as this system information.

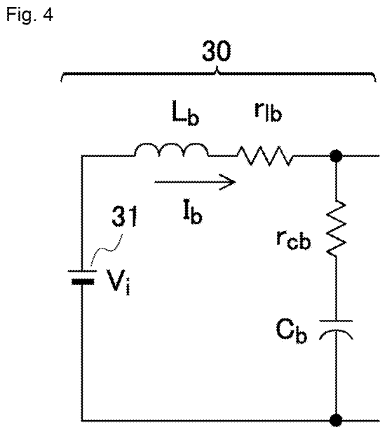

LC parallel circuit designation information for handling the power supply side portion 30 of the analysis target system as an LC parallel circuit with the configuration shown in FIG. 4.

Output voltage V_{b} (hereinafter, also referred to as DC bus voltage V_{b}) of DC power supply 31 (converter that converts system voltage to DC, or the like)

Inductance Lₘ and armature resistance Rₘ of the electric motor 42 of each servo device

Proportional gain Kₚ and integral gain Kᵢ of the current compensator 45 (FIG. 3) of each servo device

Operation pattern information on each servo device

It should be noted that the operation pattern information on each servo device is a command value group (time series data on position command and the like) input into each controller 43 in order to operate each servo device. The use of the operation pattern information will be described below, but the operation pattern information is information that can omit input.

The LC parallel circuit designation information acquired by the UI processing unit 14 from the user includes the capacity of the input capacitor and the capacity of the DC bus of each inverter circuit 41 in C_{b} in FIG. 4.

The display target designation information acquired by the UI processing unit 14 from the user is information that designates one or more DC bus currents I_{b} on which the stability analysis processing unit 15 is caused to display the Nyquist plot. The display target designation information may be information for directly designating one or more DC bus currents I_{b} or information for indirectly designating one or more DC bus currents I_{b}.

The UI processing unit 14 normally stands by for the above two pieces of information (system information and display target designation information) to be input by the user. Then, when the user inputs execution instructions for the stability analysis processing after the input of the two pieces of information is completed, the stability analysis processing unit 15 is instructed to start the stability analysis processing.

The stability analysis processing executed by the stability analysis processing unit 15 is processing in which, based on the system information, the output impedance Zₒ(s) (s is the Laplace operator) of the power supply side portion 30 of the analysis target system (FIG. 2A, FIG. 2B) and the input impedance Zᵢₙ(s) of the load side portion 40 of the analysis target system are specified, and the Nyquist plot of “Zₒ(s)Zᵢₙ(s)” is displayed (output) from the specified Zₒ(s) and Zᵢₙ(s) on the screen of the display 12. In addition, the stability analysis processing is processing in which s, DC bus current 1_{b}, and a function of the conversion rate a of DC bus current lb into the q-axis current of the electric motor 42 are used as the input impedance Zᵢₙ(s) of the load side portion 40, and processing in which the Nyquist plot is displayed for each DC bus current lb designated directly/indirectly by the display target designation information.

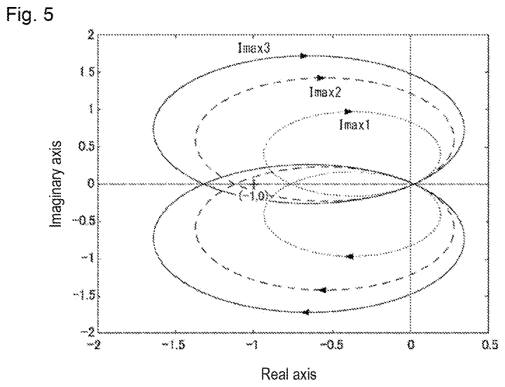

That is, although the details will be described below, when the stability analysis processing is performed, for example, a Nyquist plot as shown in FIG. 5 is displayed on the screen of the display 12. Therefore, the user can grasp the range of the DC bus current lb in which oscillation occurs/does not occur, from the positional relationship between the Nyquist plot (vector locus) in each DC bus current I_{b} and (−1, 0). It should be noted that the output by the stability analysis processing unit 15 may include not only the display processing of the above Nyquist plot onto the display 12, but also processing in the form of outputting data related to the Nyquist plot to other processing performed in a device inside or outside the design assistance device 10.

Hereinafter, the content of the stability analysis processing will be described in more detail, focusing on the case where the load side portion 40 of the analysis target system is composed of one servo device (FIG. 2A).

During the stability analysis processing, the stability analysis processing unit 15 prepares a function represented by the following Formula (A1) as the output impedance Zₒ(s) of the power supply side portion 30 of the analysis target system based on the system information (LC parallel circuit information).

$$\begin{matrix}[ Mathematical 2 ] & \\ {Z}_{0} ( s ) = \frac{{s}^{2} {L}_{b} {C}_{b} {r}_{cb} + s ( {L}_{b} + {L}_{b} {r}_{L b} {r}_{cb} ) + {r}_{L b}}{{s}^{2} {L}_{b} {C}_{b} + s {C}_{b} ( {r}_{Lb} + {r}_{c b} ) + 1} & ( A1 )\end{matrix}$$

In addition, the stability analysis processing unit 15 prepares a function satisfying the following Formula (A2) as the input impedance Zᵢₙ(s) of the load side portion 40 based on the system information (information other than the LC parallel circuit information).

$$\begin{matrix}[ Mathemathical 3 ] & \\ \frac{1}{{Z}_{in} ( s )} = \frac{1}{{Z}_{N} ( s )} \frac{T ( s )}{1 + T ( s )} + \frac{1}{{Z}_{D} ( s )} \frac{1}{1 + T ( s )} & ( A2 )\end{matrix}$$

In this Formula (A2), Z_{N}(s) is the input impedance of the servo device at the time of ideal feedback. In addition, Z_{D}(s) is the input impedance of the servo device at the time of no feedback (when there is no feedback), and T(s) is the open-loop transfer function of the servo device.

It should be noted that when the load side portion 40 of the analysis target system includes a plurality of servo devices, the stability analysis processing unit 15 can prepare the input impedance Zᵢₙₐₗₗ(s) of the load side portion 40 (all the plurality of servo devices) by combining the Zᵢₙ(s) of each servo device prepared by Formula (A2). That is, assuming that each servo device is connected to the DC bus 35 with a single axis, when Zᵢₙ(s) of each servo device is represented as Zᵢ(s) (i=1 to imax), the stability analysis processing unit 15 can prepare Zᵢₙₐₗₗ(s) that satisfies the following formula.

$$\begin{matrix}[ Mathematical 4 ] & \\ \frac{1}{{Z}_{inall} ( s )} = {{\sum }_{i = 1}}^{imax} \frac{1}{{Z}_{i} ( s )} & ( C1 )\end{matrix}$$

In addition, the input impedance of the servo device at the time of ideal feedback is-V_{b}/I_{b}. That is, Z_{N}(s) can be expressed by the following Formula (B0).

$$\begin{matrix}[ Mathematical 5 ] & \\ {Z}_{N} ( s ) = - \frac{{V}_{b}}{{I}_{b}} & ( B0 )\end{matrix}$$

In addition, it is I_{q} that is fed back in the servo device (see FIG. 3). Therefore, as Z_{D}(s) and T(s), the input impedance and the open-loop transfer function of the servo device when I_{q} is not fed back have only to be used, respectively.

The input impedance and the open-loop transfer function of the servo device when I_{q} is not fed back can be obtained from FIG. 3. However, when the functions obtained from FIG. 3 are used as Z_{D}(s) and T(s), the calculation load when displaying the Nyquist plot becomes large.

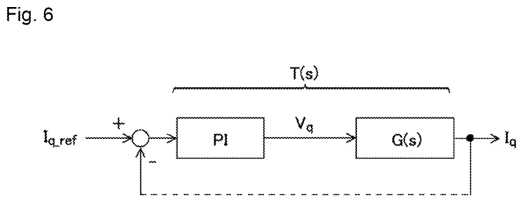

Here, considering that the responsiveness (normally, several hundred Hz) of the mechanical system of the servo device is considerably lower than the resonance frequency of the power supply side portion 30, even if the input impedance and the open-loop transfer function of the servo device when I_{q} is not fed back are obtained from the control block diagram ignoring H(s), that is, the control block diagram shown in FIG. 6, and used as Z_{D}(s) and T(s), the stability can be favorably evaluated.

Then, since PI(s) and G(s) can be expressed by the following Formulas (A3) and (A4), respectively, T(s) can be expressed by Formula (A5).

$$\begin{matrix}[ Mathematical 6 ] & \\ PI ( s ) = {K}_{p} + \frac{{K}_{i}}{s} & ( A3 ) \\ G ( s ) = \frac{1}{{R}_{m} + s {L}_{m}} & ( A4 ) \\ T ( s ) = G ( s ) P I ( s ) = ( \frac{1}{{R}_{m} + s {L}_{m}} ) ( {K}_{p} + \frac{{K}_{i}}{s} ) & ( A5 )\end{matrix}$$

In addition, the input impedance Z_{D}(s) of the servo device when I_{q} is not fed back is the electrical time constant portion of the electric motor 42. However, the input impedance Z_{D}(s) obtained from FIG. 6 is the value on the V_{q} and I_{q} sides. Therefore, by converting the input impedance Z_{D}(s) obtained from FIG. 6 into the values on the V_{q} and I_{q} sides using the following Formula (A6) (details will be described below) that holds for the conversion rate α, the stability analysis processing unit 15 prepares ZD(s) expressed by the following Formula (A7). It should be noted that in the case where the operation pattern information on each servo device has been set, when preparing the Z_{D}(s), the stability analysis processing unit 15 according to the present embodiment specifies the change pattern of speed and current command value based on the set operation pattern information using machine information such as inertia about the servo device, and calculates the conversion rate α from the specific result. In addition, in the case where the operation pattern information of each servo device has not been set, the stability analysis processing unit 15 calculates the conversion rate α by the above procedure based on the operation pattern information prepared in advance.

$$\begin{matrix}[ Mathematical 7 ] & \\ \frac{{V}_{b}}{{I}_{b}} = \frac{1}{{α}^{2}} \frac{{V}_{q}}{{I}_{q}} & ( A6 ) \\ {Z}_{D} ( s ) = \frac{1}{{α}^{2}} ( {R}_{m} + s {L}_{m} ) & ( A7 )\end{matrix}$$

The stability analysis processing unit 15 that has prepared Zₒ(s), Z_{N}, Z_{D}(s), and T(s) as described above prepares from Z_{N}, Zₒ(s), T(s), and Formula (A2) the input impedance Zᵢₙ(s) of the load side portion 40 (one servo device). Then, based on the prepared Zᵢₙ(s) and Zₒ(s), for each DC bus current lb specified directly/indirectly by the display target designation information, the stability analysis processing unit 15 displays the Nyquist plot of “Zₒ(s)/Zᵢₙ(s)” on the screen of the display 12 and then ends the stability analysis processing.

Hereinafter, some matters will be supplemented.

The Nyquist plot shown in FIG. 5 is obtained by performing the stability analysis processing under the conditions adapted to the actual system. It should be noted that as the Kₚ value and K value of Formula (A5), the values at which the frequency crossing 0 dB in the Bode plot of T(s) is a predetermined frequency are adopted. The Nyquist plot is displayed under display conditions in which the maximum currents are Imax1, Imax2, and Imax3 (Imax1<Imax2<Imax3).

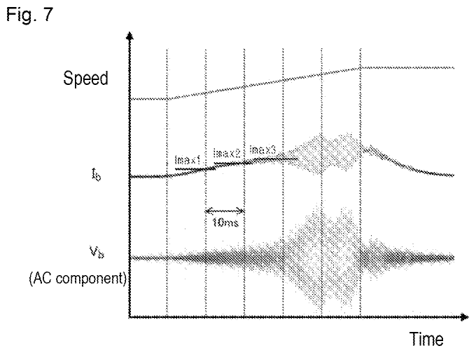

FIG. 7 shows the experimental results of actually controlling the DC power supply system in which the Lₘ value, Kₚ value, and the like are the above values.

As is clear from FIG. 7, the DC bus current lb increases as the speed increases, and it has been checked that when the DC bus current lb rises to about Imax2, the DC bus current lb and the DC bus voltage V_{b} start to oscillate according to the stability decided from the Nyquist plot shown in FIG. 5.

Thus, the design assistance device 10 (stability analysis processing unit 15) can display the Nyquist plot corresponding to the actual operation of the DC power supply system. Therefore, according to the design assistance device 10, it is possible that the configuration of the DC power supply system (for example, the specifications of the cable used as the DC cable) and the control contents for the inverter circuit 41, which are system information, are made less likely to cause vibration.

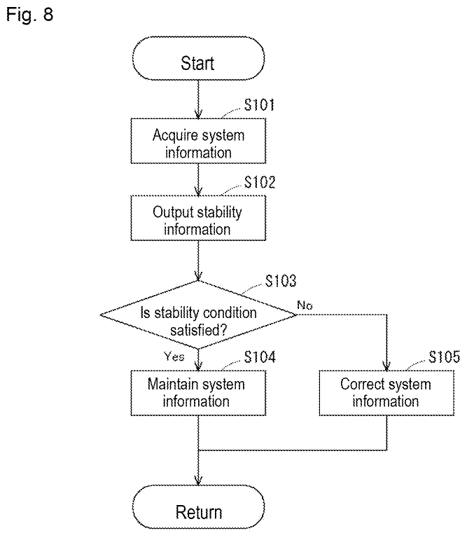

In addition, as an alternate method, the system information may be automatically corrected based on the processing result of the stability analysis processing unit 15 in the design assistance device 10. Thus, the correction processing of system information will be described with reference to FIG. 8. The control according to the flowchart shown in FIG. 8 is executed by the main body unit 13 of the design assistance device 10. First, in S101, system information is acquired. The acquisition processing corresponds to processing in which the UI processing unit 14 acquires information on the DC bus configuration and operation pattern information on the servo device as system information from the user through an operation on the input device 11. Subsequently, in S102, the stability information on the analysis target system is output. The output processing corresponds to processing in which the stability analysis processing unit 15 outputs stability information on the system stability such as a Nyquist plot.

Then, in S103, based on the stability information output in S102 and the current value required for the operation derived from the operation pattern of each servo device in the analysis target system, it is determined whether or not a predetermined stability condition is satisfied. For example, it will be described based on the Nyquist plot being the output result shown in FIG. 5. The predetermined stability condition in this case is the relative positional relationship between the Nyquist plot and (−1, 0. Here, when the maximum current value derived from the operation pattern is Imax2 Imax3, it can be determined that the predetermined stability condition is not satisfied (negative determination). On the other hand, when the maximum current value is Imax1, it can be determined that the predetermined stability condition is satisfied (affirmative determination).

Thus, if an affirmative determination is made in S103, the process proceeds to S104, and the system information acquired in S101 is maintained. That is, since the DC bus configuration corresponding to the system information acquired in S101 can secure stability even when the system information and the operation pattern of the servo device are taken into consideration, the system information does not need to be corrected and is maintained. On the other hand, if a negative determination is made in S103, the process proceeds to S105, and the system information acquired in S101 is corrected. The correction processing corresponds to the processing by the correction means of the present application. Regarding the correction of system information, as an example, the information regarding the DC bus configuration may be corrected. In this case, the specifications of the DC bus may be appropriately corrected within the range in which the operation pattern of the servo device can be achieved, and the corrected result may be displayed on the display 12.

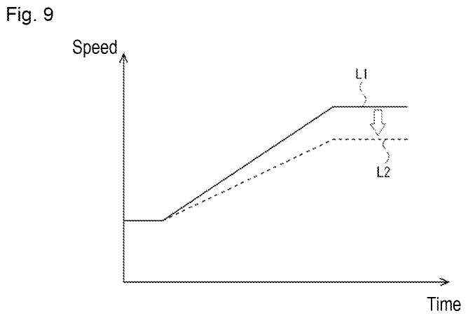

In addition, as another example of correcting the system information, in addition to the configuration of the DC bus being maintained as it is, the operation pattern included in the system information may be appropriately corrected, and the corrected result may be displayed on the display 12. For example, as shown in FIG. 9, among the operation pattern information acquired in S101, the maximum speed of the servo device is corrected from the one shown by the line L1 to the one shown by the line L2, and the corrected result is displayed on the display 12. By lowering the maximum speed in this way, the current value required for operating the servo device can be lowered, and a predetermined stability condition can be satisfied.

It should be noted that when the system information is corrected, the user may appropriately determine the acceptance of the corrected result via the input device 11.

Lastly, the reason why the above Formula (A6) holds will be described.

The following Formula (B1) holds between the DC bus voltage V_{b}, the DC bus current I_{b}, the d-axis voltage V_{d}, the d-axis current I_{d}, the q-axis voltage V_{q}, and the q-axis current I_{q}. Then, since I_{d}=0, Formula (B1) can be transformed into the following Formula (B2).

[Mathematical 8]

V_{b}I_{b}=V_{d}I_{d}+V_{q}I_{q} (B1)

V_{b}I_{b}=V_{q}I_{q} (B2)

From Formula (B2), the following Formula (B3) holds for the conversion rate a being the ratio of the DC bus current lb to the q-axis current I_{q}. Therefore, the following Formula (B4), that is, the above Formula (A6) holds.

$$\begin{matrix}[ Mathematical 8 ] & \\ α {V}_{b} = {V}_{q} & ( B3 ) \\ \frac{{V}_{b}}{{I}_{b}} = \frac{1}{{α}^{2}} \frac{{V}_{q}}{{I}_{q}} & ( B4 )\end{matrix}$$

<<Transformation Form>>

The design assistance device 10 described above can be transformed into various kinds. For example, the stability analysis processing may be transformed into processing of displaying a Bode plot of Zₒ(s) and Zᵢₙ(s), instead of a Nyquist plot of Zₒ(s)/Zᵢₙ(s). It should be noted that when the Bode plot is used, it can be determined that the stability is achieved when the magnitude of Zₒ(s)/Zᵢₙ(s) is 1 or less, or the phase difference of Zₒ(s)/Zᵢₙ(s) is 180 degrees or less. That is, when the Bode magnitude plot and the Bode phase plot of Zₒ(s) and Zᵢₙ(s) are as shown in FIG. 10, it can be determined that they are stable. In addition, the stability analysis processing may be transformed into processing of outputting data (numerical value group) representing the Nyquist plot or the Bode plot, instead of the processing of displaying the Nyquist plot or the Bode plot. When the stability analysis processing is transformed into such processing, the stability analysis processing may be provided with a function of determining whether to have stability and outputting the determination result. In addition, it is natural that some functions may be removed from the design assistance device 10, or the design assistance device 10 may be transformed into a device that inputs/outputs information via a network (in other words, a device that does not include the input device 11 or the display 12).

<<Appendix 1>>

A design assistance device (10) configured to assist design of a DC power supply system in which power is supplied from a DC power supply (31) via a DC bus (35) to one or more servo devices including an inverter circuit (41) and an electric motor (42), the design assistance device (10) including:

an acquisition unit (14) configured to acquire system information indicating a configuration of the DC bus of the DC power supply system; and

an output unit (15) configured to output information on stability of the DC power supply system based on the system information acquired by the acquisition unit (14) and a current value required for each operation of the one or more servo devices.

### DESCRIPTION OF SYMBOLS

10 design assistance device

11 input device

12 display

13 main body unit

14 UI processing unit

15 stability analysis processing unit

16 non-volatile memory

18 design assistance program

30 power supply side portion

31 DC power supply

40 load side portion

41 inverter

42 electric motor

43 controller

1. A design assistance device configured to assist design of a DC power supply system in which power is supplied from a DC power supply via a DC bus to one or more servo devices including an inverter circuit and an electric motor, the design assistance device comprising:
an acquisition unit configured to acquire system information indicating a configuration of the DC bus of the DC power supply system; and
an output unit configured to output information on stability of the DC power supply system based on the system information acquired by the acquisition unit and a current value required for each operation of the one or more servo devices.

2. The design assistance device according to claim 1,
wherein the output unit outputs information on stability of the DC power supply system based on Zₒ(s) and Zᵢₙ(s) (s is a Laplace operator) corresponding to the system information,
wherein when the DC power supply system is regarded as a connection system in which a load side portion including the one or more servo devices and a power supply side portion configured to supply power to the load side portion are connected, the Zₒ(s) is a formula expressing an output impedance of the power supply side portion as a function of s, and
wherein when the DC power supply system is regarded as the connection system, the Zᵢₙ(s) is a formula expressing an input impedance of the load side portion as a function of: s, a bus current value being a current value flowing through the DC bus, and a conversion rate a of the bus current value into a q-axis current of the electric motor.

3. The design assistance device according to claim 1, wherein the system information includes operation pattern information indicating each operation pattern of the one or more servo devices.

4. The design assistance device according to claim 1, further comprising, a correction unit configured to correct the system information to satisfy the predetermined stability condition when information regarding stability of the DC power supply system output by the output unit does not satisfy a predetermined stability condition.

5. The design assistance device according to claim 4, wherein when the system information includes the operation pattern information and information regarding stability of the DC power supply system does not satisfy the predetermined stability condition, the correction unit corrects the operation pattern corresponding to the operation pattern information so that a current value required for each operation of the one or more servo devices decreases.

6. The design assistance device according to claim 1, wherein the output unit outputs a Nyquist plot of “zₒ(s)/Zᵢₙ(s)”.

7. The design assistance device according to claim 1, wherein the output unit outputs Bode plots of zₒ(s) and Zᵢₙ(s).

8. The design assistance device according to claim 1, wherein the output unit obtains, from the following Formulas (1) to (4), the Zᵢₙ(s) when there is one servo device in the DC power supply system:
$$\begin{matrix}[ Mathematical 1 ] & \\ \frac{1}{{Z}_{i n} ( s )} = \frac{1}{{Z}_{N} ( s )} \frac{T ( s )}{1 + T ( s )} + \frac{1}{{Z}_{D} ( s )} \frac{1}{1 + T ( s )} & ( 1 ) \\ {Z}_{N} ( s ) = - \frac{{V}_{b}}{{I}_{b}} & ( 2 ) \\ {Z}_{D} ( s ) = \frac{1}{{α}^{2}} ( {R}_{m} + s {L}_{m} ) & ( 3 ) \\ T ( s ) = ( \frac{1}{{R}_{m} + s {L}_{m}} ) ( {K}_{p} + \frac{{K}_{i}}{s} ) & ( 4 )\end{matrix}$$
where, it should be noted that V_{b} and I_{b} are respectively a voltage and a current of the DC bus, Rₘ and Lₘ are respectively a resistance and an inductance of an electric motor, and Kₚ and K are respectively a proportional gain and an integral gain of PI control performed to cause a q-axis current of an electric motor to coincide with a current command.

9. A design assistance method for assisting design of a DC power supply system in which power is supplied from a DC power supply by a DC bus to one or more servo devices including an inverter circuit and an electric motor, the design assistance method comprising:
acquiring system information indicating a configuration of the DC bus of the DC power supply system; and
based on the system information and a current value required for each operation of the one or more servo devices, outputting information regarding stability of the DC power supply system.

10. The design assistance method according to claim 9, further comprising:
based on the system information and a current value required for each operation of the one or more servo devices, regarding the DC power supply system as a system in which a load side portion including the one or more servo devices and a power supply side portion configured to supply power to the load side portion are connected, specifying Zₒ(s) (s is a Laplace operator) being an output impedance of the power supply side portion, and as Zᵢₙ(s) being an input impedance of the load side portion, specifying a current value flowing through the DC bus and a function of a conversion rate a of the current value into a q-axis current of the electric motor, and
based on the specified Zₒ(s) and the specified Zᵢₙ(s), outputting information regarding stability of the DC power supply system.

11. A non-transitory computer readable medium storing a design assistance program causing a computer to operate as the design assistance device according to claim 1.
